(19) United States
(12) Patent Application Publication
(10) Pub. No.: US 2007/0245300 A1
(43) Pub. Date: Oct. 18, 2007

(54) APPARATUS, SYSTEM, AND METHOD FOR PRESENTING PROJECT SCHEDULING INFORMATION IN COMBINATION WITH WORKFLOW INFORMATION

(76) Inventors: Benjamin Chan, Orem, UT (US); Jonathan Chan, Orem, UT (US); Robert G. Metler, Woodland Hills, UT (US); Timothy E. Metler, Springville, UT (US); Nicholas G. Pasto, Orem, UT (US)

Correspondence Address: Kunzler & McKenzie, 8 EAST BROADWAY, SUITE 600, SALT LAKE CITY, UT, 84111, US

(21) Appl. No.: 11/690,128

(22) Filed: Mar. 22, 2007

Related U.S. Application Data
(60) Provisional application No. 60/743,670, filed on Mar. 22, 2006.

(51) Int. Cl. G06F 9/44

(52) U.S. Cl. 717/105; 717/104

(57) ABSTRACT

An apparatus, system, and method are disclosed for present project scheduling information in combination with workflow information. The apparatus includes a worksheet pane configured to present a worksheet with task entries for the project, a workflow pane configured to overlay representations of timing, workflow, and dependencies in the project, and a mini map pane illustrating the scope of the workflow pane relative to an overall view of the project. The workflow pane includes a date list, a plurality of task icons, and a plurality of task dependency icons. Beneficially, such an apparatus, system, and method would enable a user to efficiently understand the status of a project and manipulate elements of the project.

### CROSS-REFERENCES TO RELATED APPLICATIONS

This patent application facilitates review, modification, and management of project scheduling information and project workflow information. This application claims the benefit of U.S. Provisional Patent Application No. 60/743,670 filed on Mar. 22, 2006 for Jonathan Chan, et al. and incorporates by reference the subject matter disclosed in U.S. patent application Ser. No. 11/344,876 entitled “Apparatus, System, and Method for Project Bidding and Scheduling” and filed on Feb. 1, 2006 for Jonathan Chan, et al. and the subject matter disclosed in U.S. patent application Ser. No. 11/530,845 entitled “Apparatus, System, and Method for Managing Project Customization, Compliance, Documentation and Communication” and filed on Sep. 11, 2006 for Jonathan Chan, et al.

### BACKGROUND OF THE INVENTION

1. Field of the Invention

This invention relates to project management and more particularly relates to a user interface for a project management tool.

2. Description of the Related Art

The field of project management covers a wide range of industries. For example, the fields of residential building, commercial construction, product manufacturing, building and product design, software design, and the like require project management to perform efficiently. Typically, projects require detailed management of schedule, costs, labor, material, and the like to achieve this efficiency. Additionally, project work is often contracted out to general contractors or trade subcontractors, which requires additional bidding management.

Existing project management tools are difficult to use and fail to automate the process of project management. Functions of the tools are not integrated, and as a result, users of those tools are forced to manually transfer outputs of one tool to another tool. Existing tools typically impose rules on project managers that require tasks to be organized in such a manner that may be realistic during a planning phase but do not conform to needs of a project manager during execution of the project. Consequently, conventional tools are unable to prove useful for the life of the project and do not offer sufficient flexibility to encourage users to use the tool during execution of the projection.

Given the low level of automation and integration in existing project management tools, users must develop a high level of computer expertise to manage projects with the existing utilities. Conventional tools may use technologies such as email or fax machines, yet the data must still be manually entered into a second tool. Users must access multiple tools, manually transfer data between the tools, and adapt to different tool interfaces. As a result, project managers must incur high training costs, suffer delays or other expenses resulting from mistakes due to inadequate training, or abandon the existing tools entirely.

In addition, existing project management tools often require sophisticated computing facilities for access that are often unavailable or inconvenient to access at a project site. Often, users must access the project management tool at the computer where the tool was installed, which presents difficulty when the project worksite is remote from the computer, or when a user works at multiple worksites. Changes to the project, which are often decisions that occur remote from a computer, require a user to be physically present at a computer or the computer where the tool is installed. This adds an additional layer of complexity and delay to the use of existing project management utilities.

Furthermore, existing project management tools use user interfaces that do not convey information to the user in an easily accessible manner that allows the user to easily determine the status of tasks and the scope of the project. Additionally, in real-world project management, a task that normally requires the completion of a prerequisite task before the task commences occasionally must be scheduled before the nominal prerequisite requirement. Existing project management tools fail to allow a user to schedule such a task without removing the dependency or indicating the violation of the nominal prerequisite requirement.

### SUMMARY OF THE INVENTION

From the foregoing discussion, it should be apparent that a need exists for an apparatus, system, and method that present project scheduling information in combination with workflow information. Beneficially, such an apparatus, system, and method would enable a user to efficiently understand the status of a project and manipulate elements of the project.

The present invention has been developed in response to the present state of the art, and in particular, in response to the problems and needs in the art that have not yet been fully solved by currently available project management tools. Accordingly, the present invention has been developed to provide an apparatus, system, and method for presenting project scheduling information in combination with workflow information that overcome many or all of the above-discussed shortcomings in the art.

The apparatus to present project scheduling information in combination with workflow information is provided with a plurality of elements configured to functionally execute the necessary steps of presenting a graphical user interface for project scheduling and management. These elements in the described embodiments include a worksheet pane configured to present a worksheet for a project, the worksheet comprising one or more task entries, the task entries corresponding to a task of the project, the task entries ordered by relative dependencies between two of the tasks of the project.

The apparatus may also include a workflow pane configured to overlay representations of timing, workflow, and dependencies in the project wherein the workflow pane comprises a date list having a plurality of dates representing time during the project; a plurality of task icons, each task icon associated with at least one date on the date list and configured to represent one of a plurality of tasks of the project, wherein a position of a top of a task icon relative to the date list represents a begin date for the task represented by the task icon, and a position of a bottom of a task icon relative to the date list indicates an end date for the task represented by the task icon; and a plurality of task dependency icons, each task dependency icon configured to represent a dependency relationship between two or more of the plurality of tasks in the project, wherein each of the plurality of task dependency icons comprises a connector between two of the plurality of task icons. In a further embodiment, the apparatus includes a mini map pane illustrating a scope of the workflow pane relative to an overall view of the project, wherein the mini map pane is configured to display a simplified version of the plurality of task icons in the workflow pane.

The apparatus, in one embodiment, is configured to display a prerequisite task and a dependent task, the workflow pane displaying a task dependency icon such that the dependent task begin date is not later than the end date of the prerequisite task. In another embodiment, the apparatus is configured to display a prerequisite task and more than one dependent tasks, the workflow pane displaying a task dependency icon for each of the more than one dependent tasks connecting each of the more than one dependent tasks to the prerequisite task. In a further embodiment, the mini map pane of the apparatus includes a view window corresponding to a visible portion of the project displayed in the workflow pane. In another embodiment, the mini map pane is configured to navigate the workflow pane by changing a visible area of the workflow pane in response to moving the view window in the mini map pane.

The apparatus is further configured, in one embodiment, to include a task editor displayed in response to selection of a corresponding task icon, the task editor displaying details of a task, the details of a task comprising one or more timing parameters of the task, an assigned worker for the task, notes in relation to a task. In another embodiment, the displayed details of the task are editable by a user. In a further embodiment, the apparatus includes a date handler configured to modify one or more of a begin date and an end date for a task entry in the worksheet in response to one of a user dragging the top of a task icon relative to a date on the date list, a user dragging the bottom of a task icon relative to a date on the date list, and a user dragging the whole task icon relative to a date on the date list.

In a further embodiment, the apparatus may be configured such that the task icons in the workflow pane are optimized in response to a schedule change to a task icon in the workflow pane. In one embodiment, optimization comprises arranging the task icons relative to the date list such that the dependency relationships between the tasks are satisfied, and a schedule change comprises a change to one or more of a begin date, an end date, and a dependency relationship associated with the task.

The apparatus, in one embodiment, includes a task library pane, the task library pane configured to present one or more tasks available for inclusion in the project. The task library pane, in one embodiment, is configured to be included in the project by dragging the task to the workflow pane, the workflow pane cooperating with the worksheet pane to insert the task into the worksheet in order. In another embodiment, the one or more tasks available for inclusion in the project are arranged according to one or more hierarchies.

In a further embodiment, selecting a task entry in the worksheet pane moves a focus to a corresponding task icon in the workflow pane. The apparatus may further prompt for a selection of notification options in response to a change to the position or size of a task icon. In another embodiment, the notification options comprise selecting among one or more users impacted by a change of a task corresponding to the task icon with a changed position or size.

The workflow pane, in one embodiment, graphically indicates tasks in a critical path for the project, the critical path for the project comprising tasks that impact a completion date for the project. In another embodiment, the workflow pane visually indicates a set of tasks icons within the workflow pane for tasks in the project that satisfy a task criteria. In another embodiment, the workflow pane graphically indicates a violated dependency, wherein a violated dependency comprises a task icon positioned in a location relative to the date list that causes the dependency to be disregarded.

A system of the present invention is also presented for a user interface for construction project scheduling. In particular, the system, in one embodiment, includes a computer server having a memory and a central processing unit and configured to operate an application.

The system may further include an application operating on the computer server configured to provide a worksheet pane configured to present a worksheet for a construction project, the worksheet comprising one or more task entries, the task entries corresponding to a task of the construction project, the task entries ordered by relative dependencies between two of the tasks of the construction project. The application may also include a workflow pane configured to overlay representations of timing, workflow, and dependencies in the construction project wherein the workflow pane comprises a date list having a plurality of dates representing time during the construction project; a plurality of task icons, each task icon associated with at least one date on the date list and configured to represent one of the plurality of tasks of the construction project, wherein the position of a top of a task icon relative to the date list represents a begin date for the task represented by the task icon, and a position of a bottom of a task icon relative to the date list indicates an end date for the task represented by the task icon; and a plurality of task dependency icons, each task dependency icon configured to represent a dependency relationship between two or more of the plurality of tasks in the construction project, wherein each of the plurality of task dependency icons comprises a connector between two or more of the plurality of task icons.

In addition, the application in the system may include a mini map pane configured for illustrating the scope of the workflow pane relative to the overall construction project, wherein the mini map pane is configured to display a simplified version of the plurality of task icons in the workflow pane. The system may also include a user interface configured to provide access to the application.

The application in the system may further include an estimation tool comprising a drawing viewer configured to display a drawing relating to the project, a scaling tool configured to define a logical relationship between a distance selected in the drawing and a physical dimension, and a calculator interface configured to calculate values relating to the project, the calculator interface linked to a formula library comprising formulas for estimating values relating to the project. In one embodiment, the estimation tool includes a price library configured to provide pricing information for materials used in the project for use by the formulas in the formula library. In a further embodiment, the estimation tool may include an area measurement tool configured to compute an area for a shape defined on the drawing, the shape defined by clicking around a perimeter of the area.

Also presented is a computer program product comprising a computer readable medium having computer usable program code executable to perform operations for a graphical user interface for construction project scheduling and management. The operation of the computer program product include, in one embodiment, displaying a worksheet pane configured to present a worksheet for a construction project, the worksheet comprising one or more task entries, the task entries corresponding to a task of the construction project, the task entries ordered by relative dependencies between two of the tasks of the construction project.

The computer program product may also include operations to display a workflow pane configured to overlay representations of timing, workflow, and dependencies in the construction project wherein the workflow pane comprises a date list having a plurality of dates representing time during the construction project, a plurality of task icons, each task icon associated with at least one date on the date list and configured to represent one of the plurality of tasks of the construction project, wherein the position of a top of a task icon relative to the date list represents a begin date for the task represented by the task icon, and a position of a bottom of a task icon relative to the date list indicates an end date for the task represented by the task icon, and a plurality of task dependency icons, each task dependency icon configured to represent a dependency relationship between two or more of the plurality of tasks in the construction project, wherein each of the plurality of task dependency icons comprises a connector between two or more of the plurality of task icons.

In one embodiment, the operations of the computer program product include displaying a mini map pane configured for navigating the workflow pane, the mini map pane illustrating the scope of the workflow pane relative to the overall construction project, wherein the mini map pane is configured to display a simplified version of the plurality of task icons in the workflow pane. The workflow pane of the computer program product, in one embodiment, also includes a date restriction icon associated with a task icon, the date restriction icon indicating a date restriction for a task corresponding to the task icon. In another embodiment, the workflow pane of the computer program product includes an assigned worker icon associated with a task icon, the assigned worker icon indicating that a worker is assigned to a task corresponding to the task icon.

The computer program product may also include task icons with a color indicating a status of the task associated with the task icon. In a further embodiment, the computer program product may display tasks associated with a particular worker for the construction project. In yet another embodiment, the computer program product may display tasks associated with a particular worker for more than one construction project. The worksheet pane of the computer program product may also display tasks arranged by one or more phases of the construction project.

In one embodiment, the computer program product triggers an action in response to a change in the workflow. The change may take various forms such as a user input, completion of a task, delay of a task, or change in a task begin date or end date. The action that is triggered may also take various forms in relation to the particular project. In one embodiment, the triggered action is generation of project paperwork (such as purchase orders, contracts, plans, or other documents), issuing a materials order (for example in preparation for a dependent task or phase), initiating an automated process such as a security system, or issuing a command to an external electronic system such as a robotics system or the like.

Reference throughout this specification to features, advantages, or similar language does not imply that all of the features and advantages that maybe realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic diagram illustrating one embodiment of a display for graphically presenting project scheduling and workflow information;

FIGS. 2A-2B are illustrations of one embodiment of a workflow pane in a display for graphically presenting project scheduling and workflow information;

FIGS. 2C-2G are illustrations of one embodiment of the workflow pane 102 configured to allow a user to add a task icon 204 for a task using a multi-step Graphical User Interface process;

FIG. 3 is a schematic diagram illustrating one embodiment of a worksheet pane in a display tool for graphically presenting project scheduling and workflow information;

FIG. 4 is a schematic diagram illustrating one embodiment of a mini map pane in a display for graphically presenting project scheduling and workflow information;

FIG. 5 is a schematic diagram illustrating one embodiment of a task library pane in a display for graphically presenting project scheduling and workflow information;

FIG. 6 is a schematic diagram illustrating one embodiment of an estimation tool;

FIG. 7 is a schematic diagram illustrating one embodiment of task icons showing a non-optimal dependency relationship;

FIG. 8 is a schematic block diagram illustrating one embodiment of a system for a display for graphically presenting project scheduling and workflow information; and

FIG. 9 is a schematic block diagram illustrating one embodiment of an apparatus for display for graphically presenting project scheduling and workflow information.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

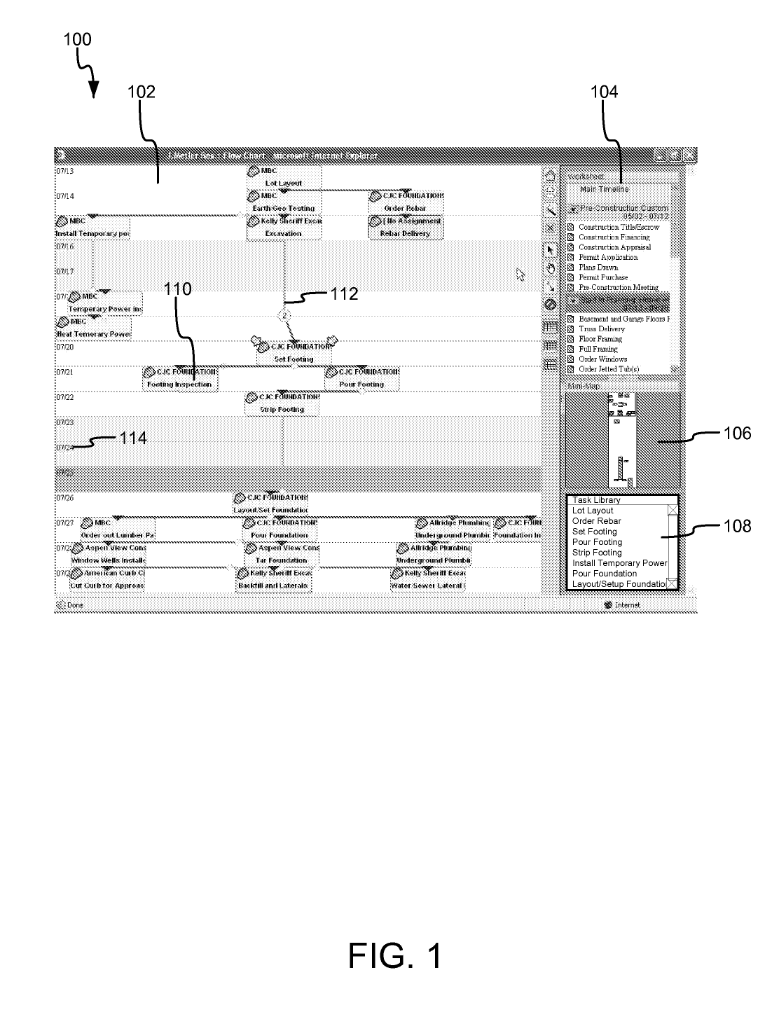

FIG. 1 is a schematic block diagram illustrating one embodiment of a graphical user interface (GUI) 100 for project scheduling and management. In one embodiment, the GUI 100 includes a workflow pane 102, a worksheet pane 104, a mini map pane 106, and a task library pane 108. The GUI 100 provides an interface for a user to create, modify, and view a schedule for a project. In one embodiment, the GUI 100 is configured specifically for a construction project.

The workflow pane 102, in one embodiment, comprises task icons 110, wherein each task icon 110 is a representation of a task in the project as it is scheduled to occur in time. The task icons 110 may be represented by rectangles arranged in the workflow pane 102. The vertical position of a task icon 110 in the workflow pane 102 corresponds to the scheduled date for the task icon 110, the scheduled date shown by the vertical position of the task icon 110 relative to a date list 114. The date list 114 includes a series of dates representing the passage of time over the course of the project.

The vertical length of a task icon 110 in the workflow pane 102 corresponds to the scheduled time required to complete the task. Those of skill in the art recognize that a date list 114 of scheduled dates may run horizontally in certain embodiments in which case the horizontal position of a task icon 110 in the workflow pane 102 corresponds to the scheduled date for the task icon 110 at the same horizontal position. Similarly, the horizontal length of a task icon 110 in a horizontal date list 114 corresponds to the scheduled time required to complete the task.

The task icons 110 in the workflow pane 102 are linked by dependencies illustrated by dependency icons 112 shown as lines connecting tasks icons 110. For example, in one embodiment, a task may be represented by a task icon 110 shown as a rectangle that begins at a vertical position corresponding to July 14 and ends at a vertical position corresponding to July 21, signifying that the task 110 is scheduled to have a begin date of July 14 and an end date of July 21. The task icon 110 representing the task may be linked to task icons 110 representing one or more other tasks, signifying that the commencement of the task depends on the completion of one or more other tasks above this task icon 110 in the workflow pane 102, or that the commencement of one or more other tasks below this task icon 110 in the workflow pane 102 depends on the completion of the task.

As will be appreciated by one skilled in the art, a variety of configurations of workflow pane 102 may be implemented without departing from the scope of the invention. For example, in one embodiment, time may be measured on a horizontal axis, such that the horizontal length of the task icons 110 corresponds to the amount of time required to complete a task. In another embodiment, the task icons 110 may be in the form of a bar, a line, an oval, or any type of shape.

In one embodiment, the worksheet pane 104 is a representation of tasks in the order they are scheduled to occur. The worksheet pane 104, in one embodiment, comprises one or more task entries, each task entry in the worksheet pane 104 corresponding to a task icon 110 in the workflow pane 102. In one embodiment, clicking (or otherwise selecting) a task entry in the worksheet pane 104 may move the focus of the GUI 100 to the corresponding task icon 110 in the workflow pane 102. In another embodiment, clicking on a task icon 110 in the workflow pane 102 may move the focus of the GUI 100 to the corresponding task entry in the worksheet pane 104.

The mini map pane 106, in one embodiment, is a representation of the task icons 110 in a project or a portion of a project similar to the workflow pane 102, but at a view zoomed out to contain an entire or overall project or portion of a project. The mini map pane 106 may include less detail relating to tasks than the workflow pane 102.

The mini map pane 106 may include a view box indicating the position of the workflow pane 102 in relation to the project or portion of a project. The mini map pane 106 simplifies navigation within a project and gives an indication of the scope of the project relative to the view in the workflow pane 102. In one embodiment, the user may click or click and drag the view box indicating the current position of the workflow pane 102 to adjust the portion of the project viewed in the workflow pane 102.

The task library pane 108, in one embodiment, provides access to tasks in the task library. A user may select a task from the task library pane 108 and insert the task into the workflow pane 102. In one embodiment, clicking and dragging a task from the task library pane 108 to the workflow pane 102 inserts the task into the project at the date where it is dropped. In another embodiment, tasks can be selected from the task library pane 108 and assigned a date to insert them into the project schedule in the workflow pane 102.

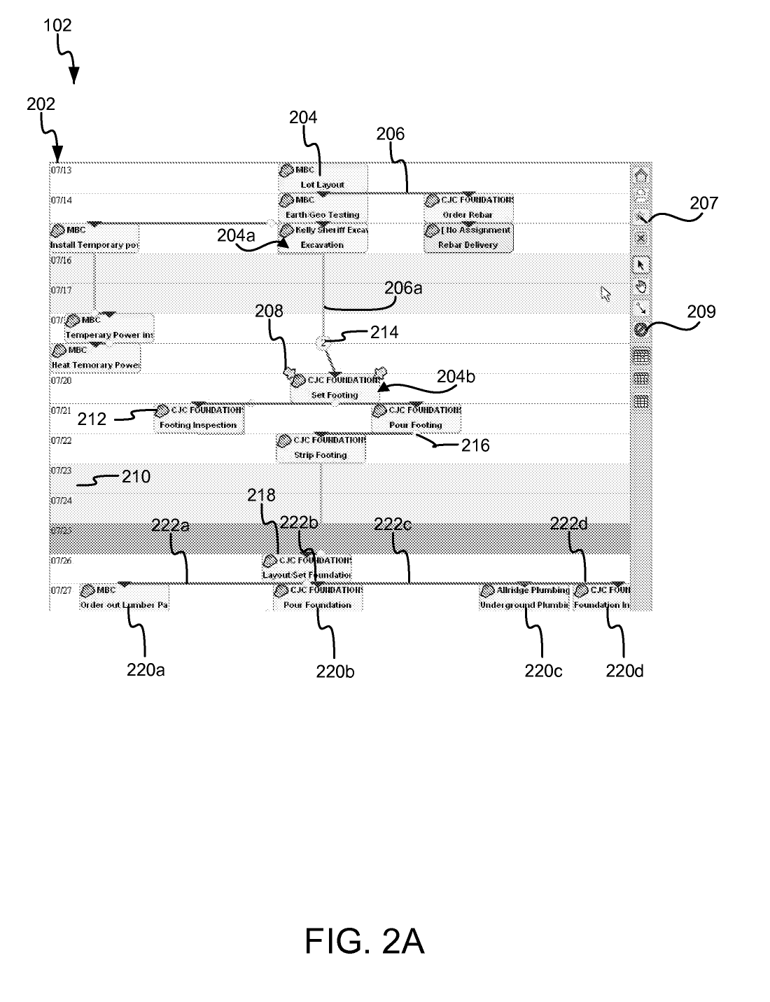

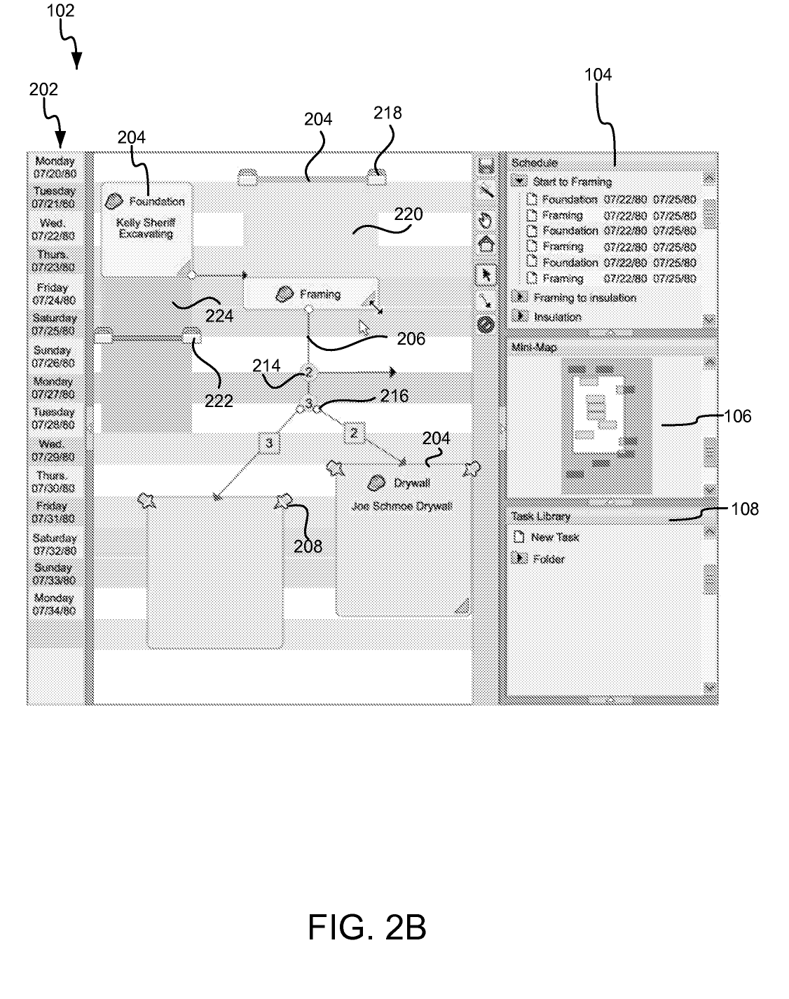

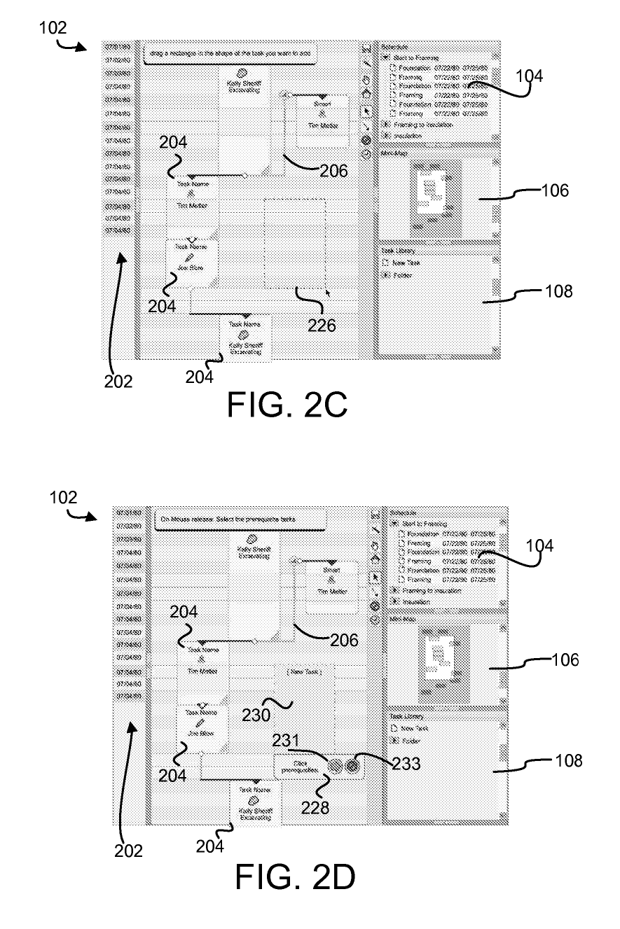

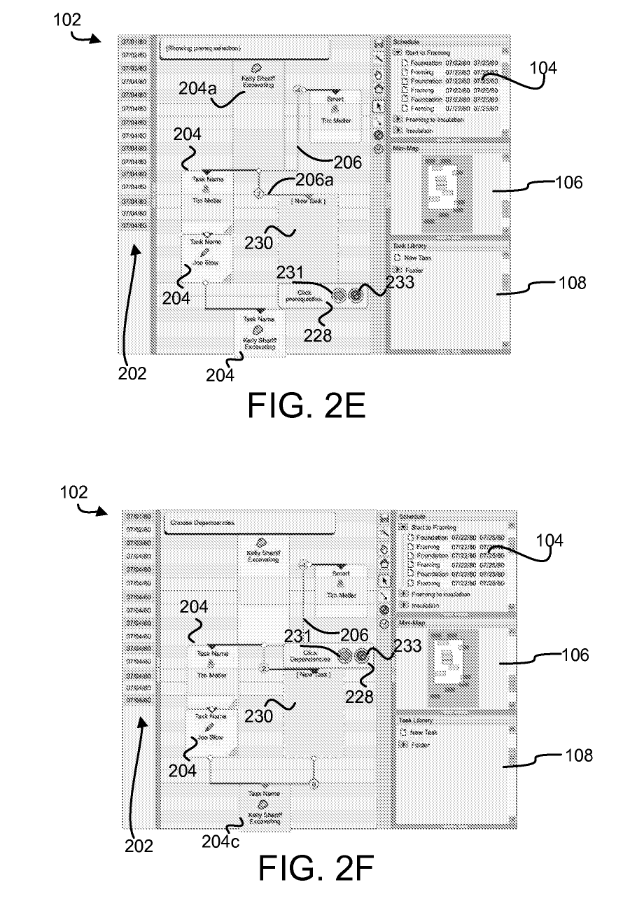

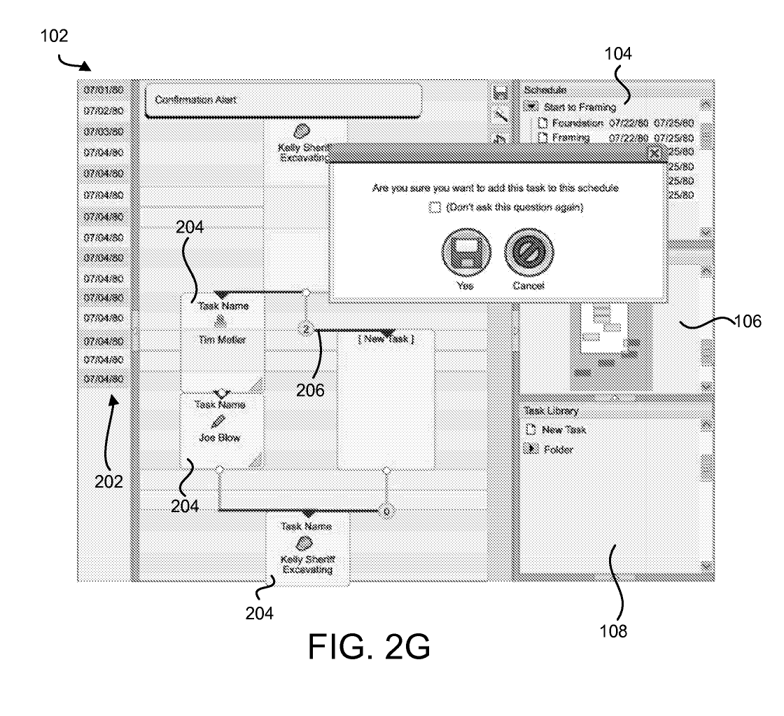

FIG. 2A illustrates one embodiment of a workflow pane 102 in a GUI 100 for project scheduling and management. The workflow pane 102 may include a date list 202, one or more task icons 204, one or more task dependency icons 206, and one or more date restriction icons 208. The workflow pane 102 is a representation of tasks as they are scheduled to occur in time and overlays representations of tasks, timing, workflow, and dependencies.

In one embodiment, the date list 202 contains dates for the project. The tasks scheduled for the date in the date column 202 are displayed as task icons 204 at the same vertical level as the date. The dates listed in the date list 202 may be actual days, such as Jul. 13, 2006. In another embodiment, the project may not have a scheduled start date, and the dates in the date list 202 may be arbitrary days, such as Day 1, Day 2, etc., or Work Day 1, Work Day 2, etc. Of course the format for the dates or days displayed in the date list 202 may be customizable by a user or otherwise configured to have varies date display formats.

The date list 202, in one embodiment, may be adjusted to show other periods of time. For example, the date list 202 may be configured to display weeks rather than individual days, such as July 17-July 23. In weekly display mode, all of the task icons 204 for tasks scheduled for the week will be displayed side by side at the same vertical level as the week in the date list 202. In another example, the date list 202 may be configured to display months, such as July.

In one embodiment, certain dates in the date list 202 may be designated as non-work days 210. Non-work days 210 are dates where work is not scheduled, such as weekends or holidays. Dates designated as non-work days 210 may be indicated on the workflow pane 102 by shading the area of the date row or portion of the date row on the workflow pane 102. In another embodiment, non-work days 210 may be removed from the workflow pane 102. In another embodiment, non-work days 210 may be rolled up into a horizontal line or made invisible in the workflow pane 102. In one embodiment, the date row on the workflow pane 102 may be shaded or colored a particular color representative of the current date. Alternatively, the current date may be represented graphically by a horizontal bar extending across the workflow pane 102 at the proper vertical position with the date rows.

The one or more task icons 204, in one embodiment, are a representation of tasks to be performed in a project. The task icons 204 correspond to tasks of a workflow and the relationship illustrated between task icons 204 is consistent with the project workflow of tasks. Advantageously, this relationship permits the user to automatically and visually review details about the project workflow in conjunction with the Gantt time information within a single view, the workflow pane 102. Task icons 204 displayed in the workflow pane 102 and task entries within the worksheet pane 104 are related such that changes to details of a task icon 204 or task entry in either interface pane automatically changes the corresponding task icon 204 or task entry in the other pane. Detail attributes of a task may be embedded within the task icon 204 and represented by additional icons on the task icon 204. The task icon 204 communicates a summary of several attributes including duration, late early, assigned to a worker or resource, flexibility of changing a task's scheduled dates, etc. Typically, this information is communicated visually, although a combination of visual cues and textual description may also be used.

The task icons 204 may be represented by rectangles, bars, lines, icons, or the like. In one embodiment, the length of time scheduled for a task is represented by the height of the task icon 204. For example, a task icon 204 scheduled to last three days would span the height of three days in the date list 202.

The width of the task icons 204, in one embodiment, may be arbitrarily set for viewing convenience and clarity. The width may be adjusted by grabbing a side of the task icon 204 and dragging it to a desired width. In another embodiment, the width of the task icons 204 may correspond to an attribute of the task, such as criticality, cost, days behind, or the like.

In one embodiment, task may be rescheduled in the workflow pane 102. A task may be rescheduled, in one embodiment, by grabbing the task icon 204 and dragging the task icon 204 to a new date indicated by the date list 202. In a further embodiment, the duration of a task may be modified by grabbing a bottom edge of the task icon 204 and dragging it up or down to change the finishing date, and thus the length of time scheduled for the task. Similarly, the beginning date of a task may be changed by grabbing a top edge of the task icon 204 and dragging it up or down. In another embodiment, a task may be rescheduled by selecting the task icon 204 and using an input such as a text box or a drop-down list to select a new scheduled date, adjust the beginning date, or adjust the end date.

The workflow pane 102 may include a date handler configured to modify the dates associated with a task in response to manipulation of a task icon 204 in the workflow pane 102. For example, when a user drags the bottom of a task icon 204 to a different date relative to the date list 202, the date handler may change an end date of the task associated with the task icon 204. Similarly, when a user drags the top of a task icon 204 to a different date relative to the date list 202, the date handler may change a begin date of the task associated with the task icon 204. Furthermore, when a user drags an entire task icon 204 to a different date relative to the date list 202, the date handler may change the beginning date and the end date of the task associated with the task icon 204. Alternatively, or in addition, the date handler in certain embodiments adjusts the begin date and end date of a task in response to a user making edits to these dates in a task editor described below.

In one embodiment, when a task is rescheduled, the people associated with the task, such as project workers, may be notified via e-mail, personal digital assistant (PDA), pager, phone, or the like. The notification may comprise an email, text, message, voice message, or the like. The GUI 100 may prompt for notification of those impacted by rescheduled tasks. In one embodiment, the GUI 100 may allow a selection between notification options, such as sending no notification, sending notifications immediately, and sending notifications at a scheduled time, such as daily or weekly. In another embodiment, the GUI may allow a selection of notification options per each impacted party, such as individual trade contractors or employees of a company.

Changes to task icons 204 in the workflow pane 102, in one embodiment, may require that the changes be saved to a database. In one embodiment, some saves may take place automatically without user input. Minor changes, such as changes to arbitrary widths or positions of task icons 204 may result in automatic, unprompted minor saves. A major save may take place when major changes are made to the project in the workflow pane 102. Major changes may include reschedules of tasks that require re-optimization of the job or notifications. In one embodiment, the GUI 100 prompts for a confirmation before performing a major save. In one embodiment, the confirmation may require a reason for the change before the change is allowed and the major save is performed. In another embodiment, the GUI 100 prompts for a confirmation before performing associated tasks such as notification or re-optimization.

The task icons 204 in the workflow pane 102, in one embodiment, may be colored to indicate attributes of the associated task. For example, a task icon 204 representing a task that is not currently assigned to a contractor may be one color, a task icon 204 representing a task that is assigned may have another color, a task icon 204 representing a task that is behind schedule may have a different color, and a task icon 204 that is selected may have yet another color.

In one embodiment, task icons 204 may be opened in a task editor to view, edit, or modify attributes of the task associated with the task icon 204. Task icons 204 may be opened in the task editor by clicking on the task icon 204, double clicking on the task icon 204, or the like. Examples of attributes that may be viewed, edited, or modified by opening a task icon 204 include notes relating to the task, the assigned worker for the task, the dates associated with the task, the status of the task, and the like.

In one embodiment, the GUI 100 allows a user to view, change, or assign a contractor for an opened task icon 204. Contractors may be selected for a task in a dialog box, by typing in a contractor name, by selecting a contractor from a pull-down menu, or the like. In one embodiment, a contractor may be quickly added and associated with an opened task icon 204 by entering the name of the contractor in a quick add dialog. In a further embodiment, more information about the contractor being added, such as contact information and the like, may be added in the quick add dialog.

In one embodiment, the dialog for viewing, changing, and assigning contractors to tasks may be configured to allow a user to view all of the tasks associated with a specific contractor or worker. In one embodiment, tasks associated with a worker or contractor across multiple projects may be viewed to indicate the workload and importance of a contractor or worker to the projects.

The task icons 204 in the workflow pane 102, in one embodiment, may include an indicator 212 showing the type of contractor associated with the task. For example, an icon such as a hard hat on the task icon 204 may indicate that the associated task is assigned to an independent contractor. In another embodiment, a particular icon may indicate that the task is assigned to a specific employee or group within a company.

The one or more task dependency icons 206, in one embodiment, are a representation of the dependencies between tasks in the project. Dependency relationships may require that a task begin after the start or completion of another task, begin a specified period of time after the start or completion of another task, or the like. For example, a rebar delivery task may be dependent on an order rebar task such that delivery must take place after ordering is complete. In another example, a set footing task is dependent on an excavation task such that the set footing task should take place two days after the excavation task is complete.

In one embodiment, dependency relationships are represented by task dependency icons 206 formed by lines between task icons 204. In one embodiment, satisfied dependency relationships are represented by horizontal and vertical lines. Task dependency icons 206 represent the optimal scheduling of the tasks based on the predefined dependencies. Variations contrary to a dependency are referred to herein as a violation of a dependency relationship.

Horizontal lines connect task icons 204 for tasks that can be performed concurrently or subsequent to the earlier task. Task icons 204 connected by a vertical line are dependent on the earlier task being completed or at least started. A task dependency icon 206 may include an arrow to show the direction of the relationship. Task dependency icons 206 for dependency relationships that require a set period of time between tasks may indicate that time graphically. For example, a task dependency icon 206 that requires two days delay between the completion of one task and another task may be indicated by a task dependency icon 206a comprising a vertical line equal in length to the height of two days in the date list 202. In a further embodiment, the number of days may be indicated by a delay tag 214 that may include the number. Note that the two day delay begins from the begin date of the preceding task 204a. Also, note that the two day delay relates to workdays rather than regular days that would include weekends and/or holidays. Those of skill in the art recognize that the delay time may be configured to count or exclude non-workdays in various embodiments.

In some circumstances, a task represented by a task icon 204 must be scheduled on a date that violates the dependency relationship associated with the task. A violated dependency occurs when a task icon 204 is positioned relative to the date list 114 in a position that causes the dependency to be disregarded. For example, an inspection may have to be done earlier than the completion date of a task such as rough framing. A violated dependency relationship may be indicated graphically by a task dependency icon 206 represented by a diagonal line between the task icons 204. The task icon 204 of the dependent task may be placed earlier (toward the top) than or later than (toward the bottom) but in violation of a dependency between the two tasks.

For example, a dependency relationship represented by a task dependency icon 206a that requires two days between the completion of one task represented by a task icon 204a and another task represented by a task icon 204b with the dependent task scheduled four days after the first task may be indicated by a vertical line equal in length to the height of two days in the date list 202 connected to a diagonal line between the end of the vertical line and the dependent task icon 204b.

As will be appreciated by one skilled in the art, a variety of methods for graphically indicating a violated dependency may be employed without departing from the scope of the present invention. For example, a violated dependency may be illustrated by a diagonal line, while a satisfied dependency may be illustrated by a vertical line. In another example, a violated dependency may be illustrated by a line in a different color than a satisfied dependency. In yet another example, a violated dependency may be illustrated by a first line indicating a position for the dependent task required to satisfy the dependency connected to a second line leading to the task icon 204 violating the dependency.

In one embodiment, a task icon 204 in the workflow pane 102 may indicate its dependency relationships by way of a task dependency icon 206. For example, clicking on a task icon 204 may cause highlighting for related task icons 204 to change color. In one embodiment, satisfied task dependency icons 206 may be one color, and unsatisfied task dependency icons 206 may be another color. Unsatisfied task dependency icons 206 represent task dependencies with conditions that are unmet. For example, a task dependency may require that a dependent task be performed after a prerequisite task, but the dependent task may be scheduled to occur before the end of the prerequisite task due to other constraints, resulting in the task occurring before the dependent date. Likewise, a dependent task may be constrained to occur after the dependent date required by the task dependency. In a further embodiment, unsatisfied task dependency icons 206 that result in a task occurring after the dependent date may be one color, and those occurring before their dependent date may be another color. Advantageously, the coloring permits a user to quickly review dependencies and make adjustments as needed.

The workflow pane 102 may be configured, in one embodiment, to allow a user to define dependency relationships with task dependency icons 206 between task icons 204. In one embodiment, the user may create task dependency icons 206 between task icons 204 in the workflow pane 102 by choosing a “selection tool” 207 which changes the state of the workflow pane 102 from normal operation mode to “dependency creation” mode in which the user may click on one task icon 204a to select it, then click on another task icon 204b thereby creating a task dependency icon 206 between the two. In addition, a single task icon 204 may have other tasks that are dependent on it. The same selection tool 207 may be used to create the required dependency.

In one embodiment, the user may select an anchor node 216 and drag to a corresponding anchor node 216 of the task icon 204 representing the dependent task. In one embodiment, the user may use a dependency tool to draw a line between task icons 204, indicating a dependency relationship represented by a task dependency icon 206. In another embodiment, the user may select a task icon 204 and define dependency relationships using dialog boxes, pull down lists, or the like. A delete button 209 may remove a selected task icon 204 from the workflow and from the workflow pane 102 when activated.

In one embodiment, task icons 204 may have associated date restrictions 208 wherein a task may have a “hard date” restriction wherein the task should be scheduled on a given date, a “this date or before” restriction wherein a task should be scheduled on or before a given date, and a “this date or after” restriction wherein a task should be scheduled on or after a given date. Task icons 204 may be associated with date restrictions 208 by selecting the task icon 204 and selecting the date restriction 208 from a pull-down dialog, a menu, a right-click pop-up menu, or the like. In another embodiment, date restrictions 208 may be applied to task icons 204 using a date restriction tool.

Date restrictions 208 associated with a task icon 204 may be indicated graphically on the task icon 204 in the workflow pane 102. In one embodiment, date restriction icons 208 may indicate the presence of a date restriction 208 with a task. For example, a “hard date” restriction may be indicated by a thumbtack icon 208.

The workflow pane 102, in one embodiment, illustrates a dependency between one prerequisite task icon 218 and more than one dependent task icon 220a, 220b, 220c, 220d. In this embodiment, a task dependency icon 222a-d for each dependent task icon 220a-d illustrates the dependency of the multiple dependent tasks on the prerequisite task. The dependent task icon 220a, 220b, 220c, 220d in this example are all aligned horizontally because they begin on the same date and end of the same date. These dependent task icon 220a, 220b, 220c, 220d represent concurrent tasks that each depend on the completion of the prerequisite task, illustrated by prerequisite task icon 218. Of course any of the dependent tasks may be adjusted to have different begin dates or end dates and still depend from the same prerequisite task. The workflow pane 102 illustrates these changes using the proper task dependency icons.

FIG. 2B illustrates another embodiment in which a “this date or after” restriction may be indicated by a padlock icon 218 on an icon for the task 204. The padlock icon 218 may be aligned horizontally with the restriction date; the task icon 204 may include a range of dates available after the restriction date indicated by a shaded vertical column 220 below the padlock icon 218. The padlock icon 218 communicates visually that the task associated with this task icon 204 has a date restriction preventing the task icon 204 from being moved to earlier in the schedule. Similarly, a “this date or before” restriction may be indicated by a padlock icon 222 on the restriction date with a range of dates available before the restriction date indicated by a shaded vertical column 224 above the padlock icon 222. Restriction dates or date ranges may be editable by double-clicking on the associated icons. Restriction dates may apply to start dates and end dates for a task icon 204.

In one embodiment, the workflow pane 102 may indicate task icons 204 in a critical path. A task icon 204 in the critical path is a task that impacts the completion date of the project. By indicating the tasks in the critical path, the GUI 100 allows the user to adjust the parameters of tasks in the critical path to manually reduce the time to complete the project. For example, if a user sees that a task icon 204 with a “hard date” restriction is in the critical path, the user may opt to remove or change the “hard date” restriction to reduce the time needed to complete the project.

The critical path, in one embodiment, is indicated in the workflow pane 102 by highlighting the task icons 204 and task dependency icons 206 in the critical path. In one embodiment, the critical path task icons 204 are indicated by applying a red color to the task icons 204. The critical path may be displayed in the workflow pane 102 in response to the selection of a menu option or a tool. In another embodiment, the critical path may constantly be indicated in the workflow pane 102.

When parameters associated with a task in the critical path are changed, the project schedule may be re-optimized and a new critical path may be determined, in one embodiment. The new critical path may indicate that different task icons 204 are now in the critical path, and the user may again choose to adjust the parameters of one or more tasks in the critical path to further reduce the time needed to complete the project. Advantageously, all of these changes may be made from the workflow pane 102.

Alternatively, in certain embodiments, the workflow pane 102 is configured to indicate different types of paths or groupings of tasks and/or task dependencies (by way of the respective icons 204, 206) in the workflow based on other types of task criteria. For example, a worker assigned to a task, a label for the tasks, or a path having the least number of tasks, tasks that last for more than 2 days, tasks that are no longer than one day, or the like. In certain embodiments, the task criteria are predefined. For example, one set of task criteria may be that the workflow pane 102 indicate which tasks from the beginning of the workflow to the end are part of the fewest number of tasks from start to finish. The members of this group may be indicated by different colors, highlighting, flashing graphics, or the like. Alternatively, the user may provide the task criteria through a user input window or box. The workflow pane 102 may then indicate the tasks (by way of the task icons 204) and/or task dependency icons 206 that satisfy the task criteria.

FIGS. 2C-2G illustrate one embodiment of the workflow pane 102 configured to allow a user to add a task icon 204 for a task using a multi-step GUI process. In FIG. 2C, initially a user drags open a selection box 226 that indicates the position and size of the new task to be inserted. The height of the selection box 226 indicates the number of days or weeks the new task is to take. Advantageously, the user need not enter any data such as a numeric value for the duration.

In FIG. 2D, a mini-wizard popup prompt 228 may guide the user through selecting a task 204a upon which the new task 230 will depend. The mini-wizard popup prompt 228 may include a continue button 231 and a cancel button 233. The user then selects the task icon 204a upon which the new task represented by a new task icon 230 will depend. FIG. 2E illustrates that the selected task icon 204a is highlighted. A new task dependency icon 206a is also created between the two task icons. If the incorrect task icon 204a was selected, selecting the cancel button 233 may undo the selection. FIG. 2F illustrates selection of a task icon 204c that depends on the new task represented by a new task icon 230. If no tasks depend on the new task, selecting the continue button 231 may complete the add task process. Similarly, once a dependent task icon 204c is selected the add task process completes and the workflow pane 102 returns to a normal operation mode.

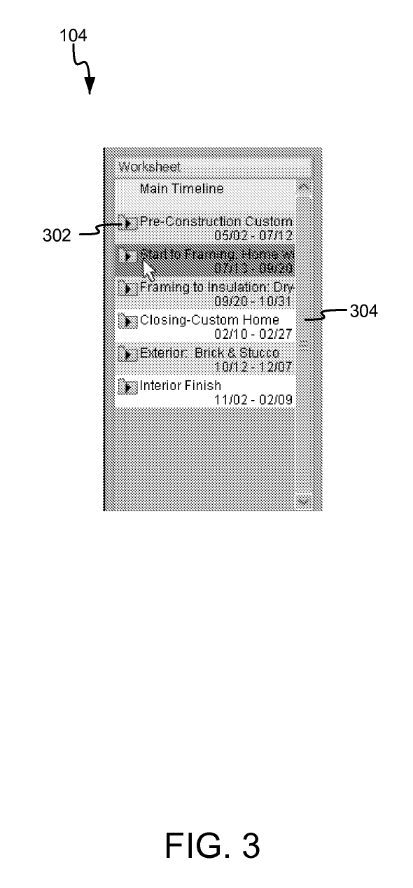

FIG. 3 illustrates one embodiment of a worksheet pane 104 in a GUI 100. The worksheet pane 104 may include one or more worksheet items 302 and a scroll bar 304. The worksheet pane 104 depicts the general order of tasks or groups of tasks to be completed in a project.

In one embodiment, the one or more worksheet items 302 may comprise one or more tasks 204 associated with a project ordered in the general order defined by the dependencies of the tasks 204. In another embodiment, the worksheet items 302 may comprise groups of tasks organized into phases. For example, a Start to Framing phase in the worksheet pane 104 may consist of a group of tasks, such as excavation, pouring a footing, pouring a foundation, and the like.

The worksheet items 302, in one embodiment, may be organized hierarchically, such that one worksheet item 302 may contain one or more other worksheet items 302. In one embodiment, worksheet items 302 may be nested in multiple hierarchical levels. For example, a start to framing phase worksheet item 302 may include a nested foundation worksheet item 302. The foundation worksheet item 302 may include a set of nested worksheet items 302, such as a set foundation task, a pour foundation task, a backfill task, and the like.

In one embodiment, hierarchical levels of worksheet items 302 may be expanded and collapsed. The worksheet items 302 may be expanded or collapsed by selecting the worksheet item 302, by double-clicking the worksheet item 302, by clicking an expand or collapse icon, or another similar method.

Worksheet items 302, in one embodiment, may include task entries corresponding to a task icon 204 in the workflow pane 102. Task entries in the worksheet pane 104 provide a method for jumping to a corresponding task icon 204 in the workflow pane 102. In one embodiment, clicking on the worksheet item 302 moves the window of the workflow pane 102 to include the task icon 204 associated with the worksheet item 302. In another embodiment, clicking on a worksheet item 302 selects the task icon 204 in the workflow pane 102 associated with the task entry.

The scroll bar 304, in one embodiment, allows the user to adjust the view of worksheet items 302 when the number of worksheet items 304 exceeds the amount of space in the worksheet pane 104. The scroll bar 304 may be manipulated to move the view of the worksheet pane 104 up or down by an item at a time or a page at a time.

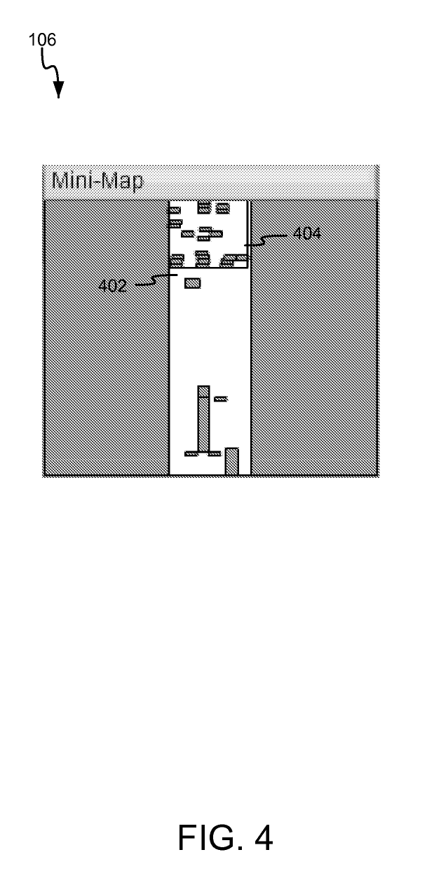

FIG. 4 illustrates one embodiment of a mini map pane 106 in a GUI 100 for project scheduling and management. The mini map pane 106 may comprise a simplified Gantt chart 402 and a view window 404. The mini map pane 106 indicates the position of the view of the workflow pane 102 relative to the rest of the project.

The simplified Gantt chart 402, in one embodiment, comprises a Gantt chart for a project similar to the task icons 204 in the workflow pane 102 with graphical representations of tasks icons 204 relative to time. The simplified Gantt chart 402 may include less detail than the workflow pane 102 to give the user an overall view of the scope of the project in a condensed form. For example, in one embodiment, the simplified Gantt chart 402 may include the shape and configuration of task icons 110, but lack task names or a date column.

In one embodiment, the simplified Gantt chart 402 may depict a subset of the project. For example, the simplified Gantt chart 402 may illustrate a simplified view of one phase of a project. In this embodiment, the simplified Gantt chart 402 gives the user a quick overview of a particular phase of a project.

The view window 404, in one embodiment, indicates the area of the simplified Gantt chart 402 being displayed in greater detail in the workflow pane 102. The view window 404 helps the user to understand the scope of the view in the workflow pane 102 relative to the overall project or phase of the project. In one embodiment, the view window 404 may be moved to change the view in the workflow pane 102. For example, a user may drag the view window 404 across the simplified Gantt chart 402 to view a new area of the project in the workflow pane 102.

In another embodiment, the view window 404 may be resized to change the scope of the view in the workflow pane 102. For example, a corner of the view window 404 may be dragged to a new location that decreases the size of the view window 404, resulting in a smaller scope of view in the workflow pane 102. Similarly, dragging an edge of the view window 404 such that the size of the view window 404 increases may result in a broader scope in the workflow pane 102.

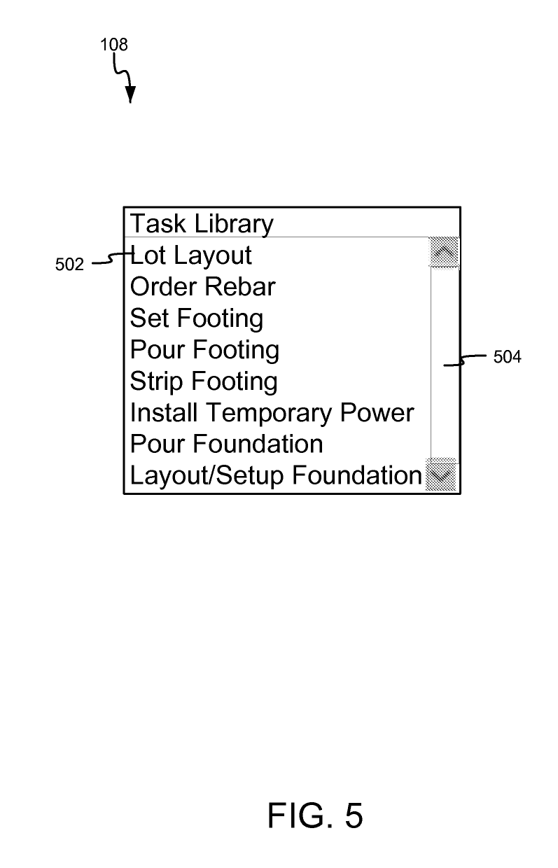

FIG. 5 illustrates one embodiment of a task library pane 108 in a GUI 100 for project scheduling and management. The task library pane 108 may include one or more tasks 502 and a scroll bar 504. The task library pane 108 provides access to tasks 504 to be added to the project.

In one embodiment, the tasks 504 in the task library pane 108 comprise all tasks contained in the task library. In an alternate embodiment, the task library pane 108 includes a subset of the tasks in the task library. The tasks 504 in the task library pane 108 may be organized into one or more hierarchical levels, or the tasks 504 may be in a single hierarchical level. In one embodiment, the task library pane 108 is configured to switch between hierarchies. For example, the task library pane 108 may include an option to arrange the tasks 502 in hierarchies corresponding to phases from the worksheet pane 104, and another option to arrange the tasks alphabetically. In an alternate embodiment, the task library pane 108 may be configured to allow a user to perform a search for a task 502 in the task library.

Tasks 504, in one embodiment, may be added to the project from the task library pane 108. In one embodiment, the task library pane 108 may be configured to allow a user to drag a task from the task library pane 108 to the workflow pane 102. A task dragged to the workflow pane 102 becomes a task icon 204 and a part of the project.

In an alternate embodiment, the task library pane 108 may be configured to allow a user to select a task 504 and define parameters for the task 504 to add it to the project. For example, a user may select a task 504 and indicate dependency relationships between the task 504 and task icons 204 in the workflow pane 102. After the relationships are defined, a task icon 204 corresponding to the task 504 is placed at the appropriate position in the workflow pane 102.

The scroll bar 504, in one embodiment, allows the user to adjust the view of tasks 502 when the number of tasks 502 exceeds the amount of space in the task library pane 108. The scroll bar 504 may be manipulated to move the view of the task library pane 108 up or down by an item at a time or a page at a time.

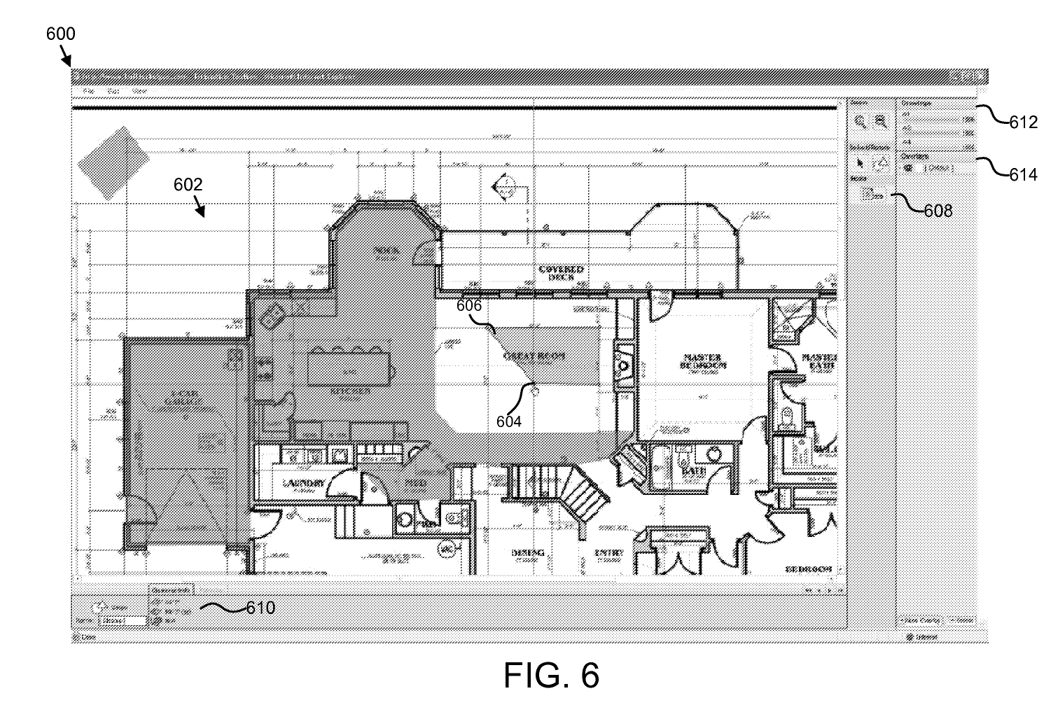

FIG. 6 is a schematic diagram illustrating one embodiment of an estimation tool user interface 600. In one embodiment, the estimation tool interface 600 includes a drawing viewer 602. The drawing viewer 602 may be configured to load images of floor plans, schematic drawings, blueprints, and the like. The drawing viewer 602 may load a Joint Photographic Experts Group (JPEG) image of the original drafted plans. One benefit of loading a JPEG image of the original is the ability to protect proprietary plans from theft or unauthorized use and copying. Of course the format of the image may be one of a variety of other existing standard or proprietary, or newly adopted, image formats as well including Tagged Image File Format (TIFF), Portable Network Graphics (PNG), portable document format (pdf), Shockwave™ flash format (SWF), and the like.

The estimation tool user interface 600 may additionally include a pointer tool 604. The pointer tool 604 may include colored crosshairs for precise positioning and measurement. The pointer tool 604 may be used to create drawing modification and redline layers, area measurement layers, and the like. In one embodiment, an area measurement shape 606 may be created using the pointer tool 604 by clicking around the perimeter of an area to be measured.

In one embodiment, the estimation tool user interface 600 may include a scaling tool. The scaling tool may be used to assign a dimensional scale to the JPEG drawing. In one embodiment, the scaling tool assigns the scale to the drawing 602 by creating a logical relationship between a distance selected in an overlaid layer and a physical dimension. For example, a user may trace a one inch line on the JPEG drawing 602 labeled twenty five feet with the pointer tool 604. The user may then enter the length twenty five feet in relation to the inch long line traced on the drawing 602. From that point on, the estimation tool creates a twenty five foot per inch relationship for all lines drawn in overlaid layers on the drawing 602.

Additionally, the estimation tool user interface 600 may include a tool bar 608. In one embodiment, the tool bar 608 may include zoom tools, shape selection tools, measurement tools, and the like. The estimation tool user interface 600 may also include a calculator interface 610, a list 612 of drawings available for viewing, and a list 614 of layers overlaid on the drawing currently loaded in the viewing window 602.

In one embodiment, the calculator interface 610 is configured to allow access to formulas for use in estimating, such as converting square feet to cubic yards of concrete for a given thickness. In one embodiment, formulas are provided by a formula library available to all users of the estimation tool user interface 600.

In another embodiment, the calculator interface 610 is configured to allow a user to create custom formulas. Custom formulas may be saved for later use by the user. In one embodiment, custom formulas developed by a user may be added to the formula library for use by other users.

The estimation tool user interface 600, in one embodiment, may include access to a price library. The price library may include price information for materials for use in the project. For example, the price library may include the current price per cubic yard of concrete from a particular supplier or the best price among a plurality of suppliers.

In one embodiment, the price library is tied to the calculator interface 610 such that a user can quickly integrate current pricing into calculations and generate bids. For example, a user may use the pointer tool 604 to create an area 606, and select the calculator interface 610, which applies a formula to the area 606 to determine the amount of concrete required for the area 606, and determines a material cost for the concrete by integrating the data from the price library.

In one embodiment, the price library retrieves price data from vendor websites. In another embodiment, vendors input price data into the price library. In a further embodiment, users input price data into the price library.

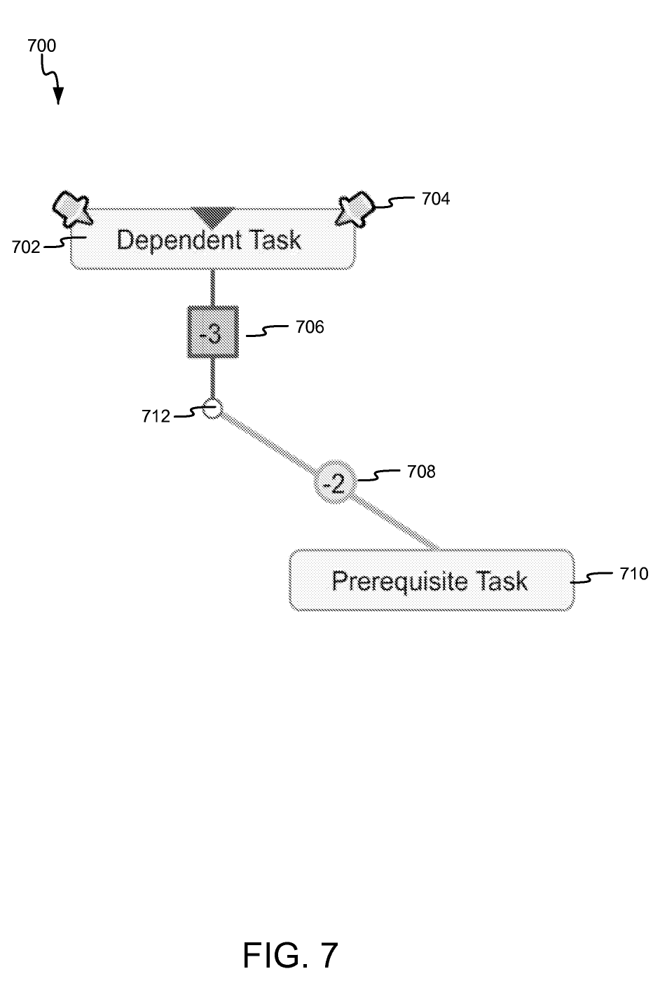

FIG. 7 illustrates one embodiment of task icons showing a non-optimal dependency relationship 700. Included are a dependent task icon 702, a date restriction icon 704, a non-optimal dependency icon 706, a dependency icon 708, and a prerequisite task icon 710. A task in a non-optimal position is graphically illustrated by the non-optimal dependency icon 706. In certain embodiments, a non-optimal dependency relationship is referred to as a violated dependency.

In certain embodiments, a date restriction on a task (represented by the date restriction icon 704) may result in a task being scheduled at a date that violates a dependency relationship. For example, a dependent task may have a dependency on a prerequisite task that requires the dependent task to begin two days before the prerequisite task. The dependent task may also have a date restriction requiring the task to begin on a specific date. Under certain circumstances, it may not be possible to satisfy both the date restriction and/or the dependency. As a result, the dependent task may be scheduled on a day that causes a non-optimal dependency relationship 700.

The dependent task icon 702, in one embodiment, corresponds to a task in a construction project. The position of the dependent task icon 702 in a workflow pane 102 indicates the timing for the dependent task represented by the dependent task icon 702. In one embodiment, the dependent task may have an associated date restriction, indicated by a date restriction icon 704. The date restriction limits the time positioning of the task. For example, a date restriction may require that a task begin on a specific date.

A date restriction may cause the task to be scheduled on a date that is non-optimal for a dependency relationship. Typically, a dependency relationship means that the dependent task follows the prerequisite task in the workflow. Advantageously, the present invention graphically illustrates such a condition.

Those of skill in the art recognize that a workflow of tasks displayed in combination with the dates associated with beginning and completing the tasks is a very useful planning tool for a project. Furthermore, during the planning phases of a project the tasks may be defined such that dependent tasks always follow prerequisite tasks. However, conventional planning tools are unable to provide the flexibility in a graphically displayed workflow and timeline to account for inevitable changes to the schedule.

Advantageously, the embodiments of the present invention provide this flexibility in combination with automatically optimizing the workflow and schedule as circumstances call for changes to the schedule. For example, in a construction project, the general contractor manages a variety of third parties who may each participate in the project by completing one or more tasks. Furthermore, the general contractor must coordinate the building schedule with that of government officials for tasks such as permitting and inspections. In addition, illnesses and weather may affect the ability for the planned workflow to become a reality.

The embodiments of the present invention permit a user to readily view the workflow of a project during the time that the project is being carried out. Advantageously, the user can see the dependencies and the timeline set out in a single view. In addition, the user can quickly make changes by graphically adjusting the position of task icons 204. In addition, the workflow pane 102 permits a user to adjust the position of a dependent task (represented by a dependent task icon 702) such that the dependent task precedes a prerequisite task (represented by a prerequisite task icon 710) in order to more accurately determine the impact of the change on the remainder of the schedule for the project. Thus, a user can dynamically adjust the tasks (by their associated icons) of a workflow graphically and see the changes graphically such that the overall workflow reflects the realities that are impacting the project. These dynamic on-the-fly changes are referred to herein as “non-optimal dependency relationships.”

Such a non-optimal dependency relationship may be graphically illustrated by a non-optimal dependency icon 706. The non-optimal dependency icon 706, in one embodiment, is a vertical red line connecting the end of a dependency icon 708 and the dependent task icon 702. In one embodiment, the non-optimal dependency icon 706 includes a number indicating the length of time the schedule of the dependent task differs from the optimal schedule date.

The dependency icon 708 graphically illustrates the optimal schedule for the dependent task. The dependency icon 708 runs from the prerequisite task icon 710 to an optimal position 712 for the dependent task icon 702. In one embodiment, the dependency icon 708 may include a number indicating a length of time for a time buffer for the dependency relationship. For example, the dependency relationship may require that a dependent task begin two days before the start of a prerequisite task, and the dependency icon 708 may include a “−2” number indicating this two days before time buffer. Alternatively, there may be no time buffer and the prerequisite task icon 710 may be aligned with the optimal position 712.

An example of a circumstance that requires a non-optimal dependency relationship occurs when a framing inspection task must occur after a framing task is complete. If a framing inspector is only available on a date two days before the scheduled completion of the framing task, and the framing inspection task is therefore scheduled two days before the completion of the framing task, the dependency is violated. The framing inspector, however, may agree that inspection two days before framing is complete is sufficient and agree to perform the inspection on that date. In this example, the workflow pane 102 may include a non-optimal dependency icon 706 linking a prerequisite task icon 710 representing the framing task and a dependent task icon 702 representing the framing inspection task. The non-optimal dependency icon 706 graphically shows that the framing inspection task depends on the completion of the framing task, and that the dependency is violated.

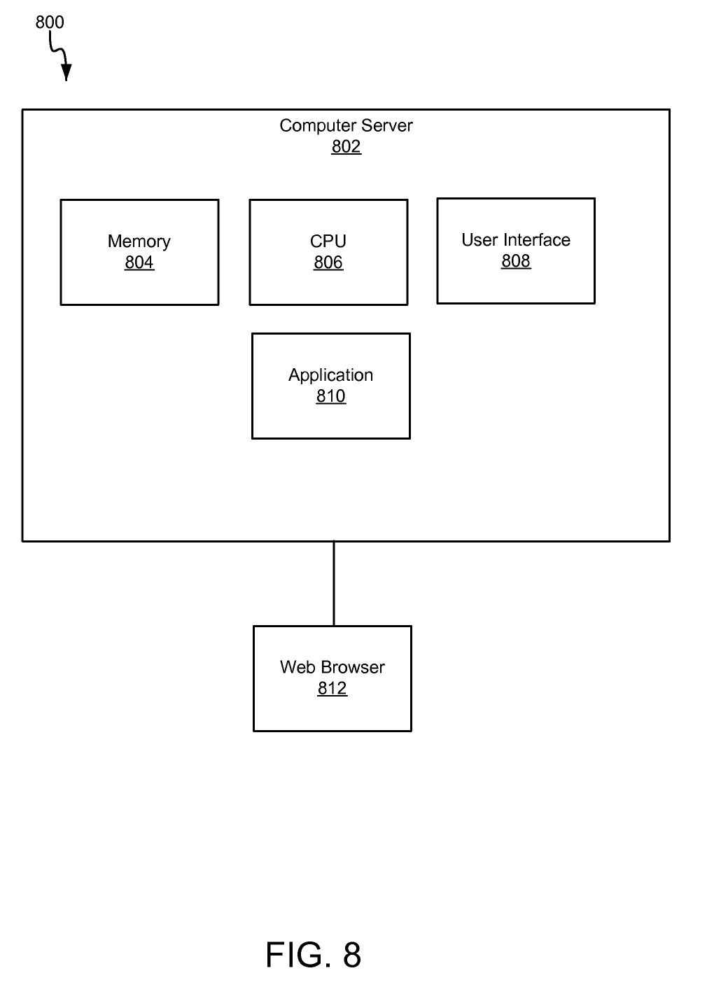

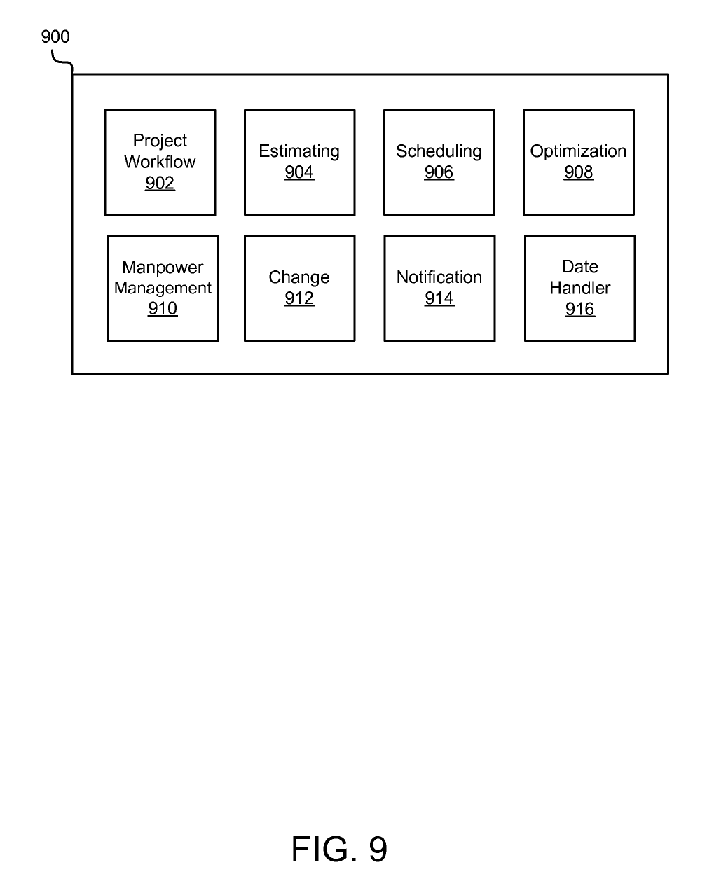

FIG. 8 is a schematic block diagram illustrating one embodiment of a system 800 for graphically presenting project scheduling and workflow information. In one embodiment, the system 800 includes a computer server 802, memory 804, a central processing unit (CPU) 806, a user interface 808, and an application 810. The system 800 graphically presents project scheduling and workflow information and provides the logic to allow for manipulation of a project represented in the GUI.

The computer server 802, in one embodiment, provides application services, web services, mail services, data storage services, and communication services, wherein the services are utilized to support operations of the invention described herein. Additionally, the computer server 802 may host an apparatus, software application, or the like to perform certain operations of the disclosed invention. In one embodiment, a single computer server 802 may provide some or all of these services. Alternatively, a plurality of computer servers 802 may be connected and perform these services individually.

In one embodiment, the memory 804 stores data for use by the computer server 802. The memory 804 may be any type of hardware device capable of storing data, such as random access memory (RAM), read only memory (ROM), flash memory, magnetic memory, or the like. The CPU 806 processes operations and executes commands for the system 800. The CPU 806 may be any type of processor capable of performing operations. Examples of CPUs 806 include processors by Intel™, Advanced Micro Devices™, Motorola™, and International Business Machines™.

The user interface 808 is configured to provide a user interface to the functional elements of the system 800. In one embodiment, the user interface 808 is web based. For example, a user may request access to the system 800. The user interface 808 may then provide a web browser based user interface using Hyper Text Transfer Protocol (HTTP). Alternatively, the user interface 808 may provide a Graphical User Interface (GUI), a command line interface, a voice activated interface, or the like.

Additionally, the user interface 808 may provide security and access control for the system 800. For example, if a user attempts to access the system 800, the user interface 808 may provide encrypted access to the system 800. The user interface 808 may employ Secure Socket Layer (SSL) or Secure HTTP (S-HTTP) encryption to secure data transmissions between the user and the system 800.

The application 810, in one embodiment, generates the GUI for the system 800. Preferably, the software application remains on the computer server 802 where the clients use common thin-client software such as a web browser 812 to interact with the application 810. Alternatively, or in addition, components of the application 810 may be distributed for use via a data network. Data is also exchanged over a data network. In one embodiment, a data network includes a Local Area Network (LAN). Alternatively, a data network may include a wireless LAN, a Wide Area Network (WAN), the internet, a cellular data communication network, a Very Small Aperture Terminal (VSAT) or other network, and the like.

FIG. 9 is a schematic block diagram illustrating one embodiment of an apparatus 900 for project scheduling. In one embodiment, the apparatus 900 includes several framework modules configured to provide operational support for functional modules. In one embodiment, the framework modules include a project workflow module 902, an estimating module 904, a scheduling module 906, an optimization module 908, a manpower management module 910, a change module 912, a notification module 914, and a date handler module 916.

In one embodiment, the project workflow module 902 provides functionality such as general project management, job creation and management, and contractor management, and the like. In one embodiment, the project workflow module 902 may incorporate a project workflow template for a specific task. The project workflow template may provide a basic framework for management of the particular project, and specific details may be added to the template in the project workflow module 902 to create a comprehensive project overview and management utility.

In one embodiment, the project workflow module 902 interacts with the worksheet pane 104 and workflow pane 102 to accurately reflect the status of tasks within a worksheet of the project. In particular, the project workflow module 902 translates user inputs and interactions with icons on the worksheet pane 104 and workflow pane 102 into changes in the data, organization, and dependencies of tasks in the worksheet. Furthermore, the workflow module 902 translates changes to the tasks communicated by interaction with task entries in the worksheet pane 104 to appropriate changes to task icons 204, task dependency icons 206 in the workflow pane 102.

In certain embodiments, the workflow module 902 interacts with, and manages data structures representative of the date list 202 and the dependencies between tasks. Those of skill in the art recognize that these dependencies may be represented by linked lists, arrays, a hierarchical tree, or the like.

The project workflow module 902 creates a workflow pane 102 based on a worksheet representation of the workflow in memory.

In one embodiment, the estimating module 904 is configured to assist in job cost and schedule estimating. The estimating module 904 may comprise a drawing viewer 602, a scaling tool, a measurement tool, calculators, and the like. Additionally, job specification templates may be loaded to further assist in job estimation. For example, a flooring contractor may create an estimate to lay tile flooring in a kitchen of a home using the estimating module 904. The flooring contractor may load the blueprint plans (in a secure format) for the home in the drawing view, load a flooring job spec. sheet template, and set the drawing scale using the scaling tool. Then, the flooring contractor may enter a cost per unit square foot into a cost calculator based on the material and labor costs defined in a job spec. sheet or defined by the flooring contractor. Then, the flooring contractor may use a pointer to select or define a shape associated with the perimeter of the kitchen floor area on the floor plan. The estimating module 904 may then calculate the total selected square footage, and the associated cost. Additionally, the calculators may calculate volumes and other measurements related to concrete volumes, electrical requirements, ventilation systems, and the like.

In one embodiment, the estimating module 904 may additionally allow modifications to be made to the building plans. The modifications may be made by overlaying multiple drawing layers on the plan drawings. For example, a redline drawing may comprise a drawing layer and a redline layer. Additionally, the estimating module 904 may allow overlay of multiple objects on the drawing using a stamping tool. For example, an electrical contractor may stamp a symbol representing an electrical outlet, light switch, light fixture, or the like. In one embodiment, the estimating module 904 may calculate a cost based on the number of objects stamped onto the drawing.

In one embodiment, the scheduling module 906 provides scheduling details for a project, job, work crew, customer, and the like. The scheduling module 906 may include a schedule flow diagram. For example, the scheduling module 906 may be integrated with the project workflow module 902 to determine an overall project schedule. In such an example, the scheduling module 906 may provide a workflow pane 102. In one embodiment, the scheduling module 906 may provide a standalone schedule display illustrating a personal daily work schedule, a project specific work schedule, a project progress schedule, and the like.

In one embodiment, the optimization module 908 may provide schedule and cost optimization for the project. In one embodiment, the optimization module 908 may implement a scheduling or cost optimization algorithm. The optimization module 908 examines the tasks of the worksheet that represent the workflow and organizes the order and organization of these tasks relative to the dates for the project in order to determine an optimal schedule to minimize the time for the project and satisfy the restrictions of the tasks and task dependencies as much as possible. The optimization algorithm may take into account factors such as weekends, holidays, scheduling conflicts, order of job priority, job prerequisites, hard deadlines, vacation days, and the like. The optimization algorithm may also account for backordered materials, market cost of materials, overtime costs vs. schedule benefits, and other cost and scheduling factors. The optimization module 908 may use these factors along with a standard deterministic, stochastic, or other computational optimization algorithm identifiable by one possessing ordinary skill in the art of computational optimization algorithms.

The optimization module 908 may utilize any optimization algorithm common in the art. For example, a Monte Carlo algorithm may be used to cause random perturbations of parameters of the project until the project meets an optimization standard. Other examples include evolutionary algorithms, Newtonian methods, and the like.

In one embodiment, the manpower management module 910 may be used in coordination with the scheduling module 906 to manage work crews. In one embodiment, the manpower management module 910 may identify possible scheduling conflicts. The manpower management module 910 may additionally update and change scheduling information related to manpower management. In one embodiment, the manpower management module 910 maintains a Gantt chart of work crew jobs and dates. Additionally, the manpower management module 910 may identify potential manpower shortages, make adjustments to account for unplanned manpower shortages, and the like.

For example, building contractors often contract with a trade contractor to work on several homes simultaneously, or within a relatively narrow window of time. For instance, a general contractor may contract with a framing contractor to frame ten homes within a two month period. With a high volume of work and a narrow time schedule, efficient manpower management becomes critically important. The manpower management module 910, and the optimization module 908 may account for job delays, holidays, weekends, and vacations to determine the most efficient framing schedule, the number of framing crews required to accomplish the job on time, and the like.

In one embodiment, the change module 912 is configured to modify the project schedule. The change module 912 may be loaded by a trade contractor to request a schedule change. Additionally, the change module 912 may be loaded by a general contractor using a personal digital assistant (PDA) in the field to make a schedule change. In one embodiment, the change module 912 may receive a text message from a cellular telephone or pager requesting a schedule change. The change module 912 may additionally approve or reject a schedule change request. The change module 912 may shift scheduled events in accordance with approved requested changes. Additionally, the change module 912 may use the optimization module 908 to optimize the schedule shift resulting from a schedule change.

In one embodiment, the notification module 914 may send update information to users of the apparatus 900. The notification module 914 may notify users in response to schedule changes, project updates, completion of certain tasks, and the like using email, cellular network text messaging, an intra-system messaging system, synthesized voice messages, and the like. For example, in response to a schedule change, the notification module 914 may send an email to all contractors impacted by the schedule change. Additionally, the notification module 914 may send a text message to a cellular telephone of the individual contractors affected. The contractors may then check their email using a PDA, laptop computer, or workstation. Preferably, such notifications are provided asynchronously such that the notified users need not be immediately accessible when the notification is sent. In this manner, routine and regular job schedule adjustments can be made while minimizing the time and availability requirements conventionally associated with job schedule changes.

Furthermore, in one embodiment, the notification module 914 is configured to send the notifications at predefined times in relation to when the change is made. Notifications may be sent immediately or within a certain time period prior to when the change affects a user. For example, a delay in a concrete pour may be sent to the concrete finishing crew one week prior to the originally scheduled date rather than the date the change was made which may be one to two months ahead of the originally scheduled date.

In one embodiment, the notification module 914 is configured to trigger an action in response to an action in relation to the workflow. These actions may be predefined to be triggered in response to workflow changes, delays, schedule changes, project updates, completion of certain tasks, and the like. For example, in one embodiment, the notification module 914 is configured to create and send a purchase order in response to completion of a prerequisite task. For example, completion of an foundation task may be defined in the notification module 914 to trigger creation of a purchase order for the framing materials for a construction project such that the order is automatically placed based on the progress of the project. Those of skill in the art recognize that various other criteria for triggers and the corresponding triggered actions may be defined within the scope of the present invention.

The date handler module 916, in one embodiment, modifies the dates associated with a task in response to manipulation of a task icon 204 in the workflow pane 102. For example, when a user drags the bottom of a task icon 204 to a different date relative to the date list 202, the date handler module 916 may change an end date of the task associated with the task icon 204. Similarly, when a user drags the top of a task icon 204 to a different date relative to the date list 202, the date handler module 916 may change a begin date of the task associated with the task icon 204. Furthermore, when a user drags an entire task icon 204 to a different date relative to the date list 202, the date handler module 916 may change the beginning date and the end date of the task associated with the task icon 204. Alternatively, or in addition, the date handler module 916 in certain embodiments adjusts the begin date and end date of a task in response to a user making edits to these dates in a task editor.

The schematic flow chart diagrams included herein are generally set forth as logical flow chart diagrams. As such, the depicted order and labeled operations are indicative of one embodiment of the presented method. Other operations and methods may be conceived that are equivalent in function, logic, or effect to one or more operations, or portions thereof, of the illustrated method. Additionally, the format and symbols employed are provided to explain the logical operations of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated operations of the depicted method. Additionally, the order in which a particular method occurs may or may not strictly adhere to the order of the corresponding operations shown.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for graphically presenting project scheduling and workflow information, the apparatus comprising:
a worksheet pane configured to present a worksheet for a project, the worksheet comprising one or more task entries, the task entries corresponding to a task of the project, the task entries ordered by relative dependencies between two of the tasks of the project;
a workflow pane configured to overlay representations of timing, workflow, and dependencies in the project wherein the workflow pane comprises:
a date list having a plurality of dates representing time during the project;
a plurality of task icons, each task icon associated with at least one date on the date list and configured to represent one of a plurality of tasks of the project, wherein a position of a top of a task icon relative to the date list represents a begin date for the task represented by the task icon, and a position of a bottom of a task icon relative to the date list indicates an end date for the task represented by the task icon; and
a plurality of task dependency icons, each task dependency icon configured to represent a dependency relationship between two or more of the plurality of tasks in the project, wherein each of the plurality of task dependency icons comprises a connector between two of the plurality of task icons; and
a mini map pane illustrating a scope of the workflow pane relative to an overall view of the project, wherein the mini map pane is configured to display a simplified version of the plurality of task icons in the workflow pane.

2. The apparatus of claim 1, further comprising a prerequisite task and a dependent task, the workflow pane displaying a task dependency icon such that the dependent task begin date is not later than the end date of the prerequisite task.

3. The apparatus of claim 1, further comprising a prerequisite task and more than one task dependent on the prerequisite task, the workflow pane displaying a task dependency icon for each of the more than one dependent tasks connecting each of the more than one dependent tasks to the prerequisite task.

4. The apparatus of claim 1, wherein the mini map pane further comprises a view window corresponding to a visible portion of the project displayed in the workflow pane.

5. The apparatus of claim 4, wherein the mini map pane is configured to navigate the workflow pane by changing a visible area of the workflow pane in response to moving the view window in the mini map pane.

6. The apparatus of claim 1, further comprising a task editor displayed in response to selection of a corresponding task icon, the task editor displaying details of a task, the details of a task comprising one or more timing parameters of the task, a task label, and an assigned worker for the task.

7. The apparatus of claim 6, wherein the displayed details of the task are editable by a user.

8. The apparatus of claim 1, further comprising a date handler configured to modify one or more of the begin date and the end date for a task entry in the worksheet in response to one of a user dragging the top of a task icon relative to a date on the date list, a user dragging the bottom of a task icon relative to a date on the date list, and a user dragging the whole task icon relative to a date on the date list.

9. The apparatus of claim 1, wherein the task icons in the workflow pane are optimized in response to a schedule change to a task icon in the workflow pane, optimization comprising arranging the task icons relative to the date list such that the dependency relationships between the tasks are satisfied, a schedule change comprising a change to one or more of a begin date, an end date, and a dependency relationship associated with the task.

10. The apparatus of claim 1, further comprising a task library pane, the task library pane configured to present one or more tasks available for inclusion in the project.

11. The apparatus of claim 10 wherein a task in the task library pane is configured to be included in the project by dragging the task to the workflow pane, the workflow pane cooperating with the worksheet pane to insert the task into the worksheet in order.

12. The apparatus of claim 10 wherein the one or more tasks available for inclusion in the project are arranged according to one or more hierarchies.

13. The apparatus of claim 1, wherein selecting a task entry in the worksheet pane moves a focus to a corresponding task icon in the workflow pane.

14. The apparatus of claim 1, further comprising a prompt for selection of notification options in response to a change to the position or size of a task icon.

15. The apparatus of claim 14, wherein the notification options comprise selecting among one or more users impacted by a change of a task corresponding to the task icon with a changed position or size.

16. The apparatus of claim 1 wherein the workflow pane visually indicates a set of tasks icons within the workflow pane for tasks in the project that satisfy a task criteria.

17. The apparatus of claim 1, wherein the workflow pane graphically indicates tasks in a critical path for the project, the critical path for the project comprising tasks that impact a completion date for the project.

18. The apparatus of claim 1, wherein the workflow pane further comprises graphically indicating a violated dependency, wherein a violated dependency comprises a task icon positioned in a location relative to the date list that causes the dependency to be disregarded.

19. A system for graphically presenting project scheduling and workflow information, the system comprising:
a computer server having a memory and a central processing unit and configured to operate an application;
an application operating on the computer server configured to provide:
a worksheet pane configured to present a worksheet for a construction project, the worksheet comprising one or more task entries, the task entries corresponding to a task of the construction project, the task entries ordered by relative dependencies between two of the tasks of the construction project;
a workflow pane configured to overlay representations of timing, workflow, and dependencies in the construction project wherein the workflow pane comprises a date list having a plurality of dates representing time during the construction project; a plurality of task icons, each task icon associated with at least one date on the date list and configured to represent one of the plurality of tasks of the construction project, wherein the position of a top of a task icon relative to the date list represents a begin date for the task represented by the task icon, and a position of a bottom of a task icon relative to the date list indicates an end date for the task represented by the task icon; and a plurality of task dependency icons, each task dependency icon configured to represent a dependency relationship between two or more of the plurality of tasks in the construction project, wherein each of the plurality of task dependency icons comprises a connector between two or more of the plurality of task icons; and
a mini map pane configured for illustrating the scope of the workflow pane relative to the overall construction project, wherein the mini map pane is configured to display a simplified version of the plurality of task icons in the workflow pane; and
a user interface configured to provide access to the application.

20. The system of claim 19, wherein the application further comprises an estimation tool comprising:
a drawing viewer configured to display a drawing relating to the project;
a scaling tool configured to define a logical relationship between a distance selected in the drawing and a physical dimension; and
a calculator interface configured to calculate values relating to the project, the calculator interface linked to a formula library comprising formulas for estimating values relating to the project.

21. The system of claim 19 wherein the estimation tool further comprises a price library configured to provide pricing information for materials used in the project for use by the formulas in the formula library.

22. The system of claim 19 wherein the estimation tool further comprises an area measurement tool configured to compute an area for a shape defined on the drawing, the shape defined by clicking around a perimeter of the area.

23. A computer program product comprising a computer readable medium having computer usable program code executable to perform operations for graphically presenting project scheduling and workflow information, the operations of the computer program product comprising:
displaying a worksheet pane configured to present a worksheet for a construction project, the worksheet comprising one or more task entries, the task entries corresponding to a task of the construction project, the task entries ordered by relative dependencies between two of the tasks of the construction project;
displaying a workflow pane configured to overlay representations of timing, workflow, and dependencies in the construction project wherein the workflow pane comprises:
a date list having a plurality of dates representing time during the construction project;
a plurality of task icons, each task icon associated with at least one date on the date list and configured to represent one of the plurality of tasks of the construction project, wherein the position of a top of a task icon relative to the date list represents a begin date for the task represented by the task icon, and a position of a bottom of a task icon relative to the date list indicates an end date for the task represented by the task icon; and
a plurality of task dependency icons, each task dependency icon configured to represent a dependency relationship between two or more of the plurality of tasks in the construction project, wherein each of the plurality of task dependency icons comprises a connector between two or more of the plurality of task icons; and
displaying a mini map pane configured for navigating the workflow pane, the mini map pane illustrating the scope of the workflow pane relative to the overall construction project, wherein the mini map pane is configured to display a simplified version of the plurality of task icons in the workflow pane.

24. The computer program product of claim 23, wherein the workflow pane further comprises a date restriction icon associated with a task icon, the date restriction icon indicating a date restriction for a task corresponding to the task icon.

25. The computer program product of claim 23, wherein the workflow pane further comprises an assigned worker icon associated with a task icon, the assigned worker icon indicating that a worker is assigned to a task corresponding to the task icon.

26. The computer program product of claim 23, wherein a task icon further comprises a color indicating a status of the task associated with the task icon.

27. The computer program product of claim 23, further comprising displaying tasks associated with a particular worker for the construction project.

28. The computer program product of claim 23, wherein the worksheet pane is further configured to display tasks arranged by one or more phases of the construction project.

29. The computer program product of claim 23, further comprising triggering an action in response to a change in the workflow, the change selected from the group consisting of a user input, completion of a task, delay of a task, and change in task begin date or end date.

30. The computer program product of claim 29, wherein the action is selected from the group consisting of generating project paperwork, issuing a materials order, initiating an automated process, and issuing a command to an external electronic system.
